(19) United States
(12) Patent Application Publication
(10) Pub. No.: US 2008/0171256 A1
(43) Pub. Date: Jul. 17, 2008

(54) DIRECT ALCOHOL FUEL CELL

(75) Inventors: SANG-KYUN KANG, Yongin-si (KR); Eung-yeoul Yoon, Yongin-si (KR); Jin-seung Choi, Yongin-si (KR); Hye-yeon Cha, Yongin-si (KR); Joon-hee Kim, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd, Suwon-si (KR)

(21) Appl. No.: 11/856,954

(22) Filed: Sep. 18, 2007

(30) Foreign Application Priority Data
Jan. 16, 2007 (KR) 2007-4959

(51) Int. Cl. H01M 8/04

(52) U.S. Cl. 429/34

(57) ABSTRACT

A direct alcohol fuel cell (DAFC) that uses methanol or ethanol as a fuel includes a membrane electrode assembly in which an anode, an electrolyte membrane, and a cathode are stacked, a fuel chamber in which alcohol is stored, and a fuel supply system that supplies the alcohol to the anode from the fuel chamber, wherein the fuel supply system comprises: a spreader that allows the alcohol received from the fuel chamber to be uniformly distributed with respect to an entire surface of the anode; a supply control unit that controls the supply of the alcohol from the fuel chamber to an inlet of the spreader; and a buffer installed between the spreader and the anode to limitedly pass alcohol towards the anode. Accordingly, the DAFC can reduce unnecessary fuel consumption during a shutdown operation and can stably and uniformly supply fuel during a normal operation.

### CROSS-REFERENCE TO RELATED APPLICATION

This application claims the benefit of Korean Application No. 2007-4959, filed Jan. 16, 2007 in the Korean Intellectual Property Office, the disclosure of which is incorporated herein by reference.

### BACKGROUND OF THE INVENTION

1. Field of the Invention

Aspects of the present invention relate to a direct alcohol fuel cell (DAFC), and more particularly, to a DAFC having an improved structure for supplying fuel to an anode.

2. Description of the Related Art

A DAFC is an electric generator that changes chemical energy of a fuel into electrical energy through a chemical reaction. The DAFC can continuously generate electricity as long as fuel is supplied thereto. The DAFC generates electricity through a reaction between a fuel, such as methanol or ethanol, directly supplied to an anode and oxygen supplied to a cathode.

FIG. 1 is a cross-sectional view illustrating a conventional DAFC. Referring to FIG. 1, an anode 11 and a cathode 13 are disposed on both sides of an electrolyte membrane 12 and face each other. The cathode 13 is exposed to air so that the cathode 13 continuously contacts air as an oxygen source. The anode 11 is surrounded by a housing 40, and alcohol vaporized in a fuel chamber 20 is supplied to the anode 11 by limitedly passing through a vaporization membrane 30, which is a porous member. Then, electrons are generated at the anode 11 through the chemical reaction indicated by equation 1 (assuming the fuel is methanol), and the electrons move to the cathode 13 through an electrically conductive path 15 to generate the chemical reaction indicated by equation 2.

CH₃OH+H₂O⇄CO₂+6H⁺+6e⁻ [Equation 1]

3/2O₂+6H⁺+6e⁻⇄3H₂O [Equation 2]

When a load 14 is applied to the electrically conductive path 15, the generated electricity can be used. The anode 11, the cathode 13, and the electrolyte membrane 12 are typically referred to collectively as a membrane electrode assembly (MEA) 10.

In the above fuel supplying system in which a fuel vaporized through the vaporization membrane 30 is supplied to the anode 11, the fuel is continuously consumed even when the DAFC is not in operation. That is, when the supplying of fuel begins, alcohol vaporized in the fuel chamber 20 enters the anode 11 through the vaporization membrane 30. In a conventional structure as described above, even when the DAFC is not operating, alcohol in the fuel chamber 20 is continuously supplied to the anode 11 through the vaporization membrane 30, thereby unnecessarily wasting fuel. When the DAFC is not in operation, there is a high possibility that alcohol supplied to the anode 11 can penetrate through the electrolyte membrane 12 to react with oxygen at the cathode 13. That is, crossover can occur. When crossover occurs, the temperature of the MEA 10 rapidly increases, and as a result, the rate of fuel consumption increases. Accordingly, in a DAFC having the structure shown in FIG. 1, fuel consumption continues even when the DAFC is not in operation.

FIG. 2 is a cross-sectional view illustrating the conventional DAFC of FIG. 1 in an inclined position. When the conventional DAFC is used in an inclined position, a fuel concentration difference between an upper portion 31 and a lower portion 32 of the vaporization membrane 30 can occur. That is, in order to be supplied to the anode 11, the alcohol in the fuel chamber 20 is drawn into the vaporization membrane 30 by capillary action and passes through the vaporization membrane 30. However, when the DAFC is inclined, as in FIG. 2, the alcohol soaked into the vaporization membrane 30 can flood to the lower portion 32 of the vaporization membrane 30 due to gravitational force. Hence, a difference in the amount of fuel supplied to different portions of the anode 11 can occur, which can lead to an unstable electricity generation reaction. When the DAFC is tilted all the way to a vertical position, the concentration difference may be more severe.

Accordingly, there is a need to develop a DAFC in which unnecessary fuel consumption is stopped when the DAFC is not in operation and in which a fuel supply difference in the vaporization membrane when the DAFC is inclined is prevented.

### SUMMARY OF THE INVENTION

Aspects of the present invention provide a DAFC having a fuel supply structure that can minimize the unnecessary consumption of fuel when the DAFC is not in operation.

Aspects of the present invention also provide a DAFC that can uniformly supply fuel to an anode regardless of the inclination angle of the DAFC.

According to an embodiment of the present invention, there is provided a direct alcohol fuel cell comprising: a membrane electrode assembly in which an anode, an electrolyte membrane, and a cathode are stacked; a fuel chamber in which alcohol is stored; and a fuel supply system that supplies the alcohol to the anode from the fuel chamber, wherein the fuel supply system comprises: a spreader that includes an inlet that receives alcohol from the fuel chamber and that allows the alcohol received from the fuel chamber to be uniformly distributed with respect to an entire surface of the anode; a supply control unit that controls alcohol supply from the fuel chamber to an inlet of the spreader; and a buffer installed between the spreader and the anode to limitedly pass the alcohol towards the anode.

According to an aspect of the present invention, the supply control unit may comprise a supply tube that connects the fuel chamber to the inlet of the spreader, a pump that pumps the alcohol to the inlet of the spreader from the fuel chamber through the supply tube, and a valve that selectively opens and closes the supply tube.

According to an aspect of the present invention, the buffer may comprise a porous material such as a porous ceramic, a fabric, a polymer porous medium, and may have a maximum length Lₘₐₓ smaller than a capillary height h_{c} of the buffer such that a distribution of alcohol retained in the buffer by capillary force is not altered by gravity.

According to an aspect of the present invention, the spreader comprises a channel plate having a flow channel that guides the alcohol entering through the inlet of the spreader to be uniformly distributed with respect to an entire surface of the anode, and a nozzle plate that is stacked on the channel plate and that includes a plurality of nozzles that eject the alcohol in the flow channels towards the buffer.

According to an aspect of the present invention, the flow channels of the channel plate may be formed to have a uniform pressure drop from the inlet of the spreader to the nozzles, and may be formed to have a total volume to contain an amount of alcohol that is consumed in an operation of the direct alcohol fuel cell of 5 minutes or less when a further alcohol supply is stopped.

According to an aspect of the present invention, the nozzles of the nozzle plate may be formed to have a diameter of 60 μm or less so that approximately 90% or more of the total fluid pressure generated in the space between the flow channels and the nozzles is applied to the nozzles.

According to another aspect of the present invention, there is provided a direct alcohol fuel cell comprising: a membrane electrode assembly in which an anode, an electrolyte membrane, and a cathode are stacked; a fuel chamber in which alcohol is stored; and a fuel supply system that supplies the alcohol to the anode from the fuel chamber, wherein the fuel supply system comprises: a spreader that includes a plurality of inlets that receive alcohol from the fuel chamber and that allows the alcohol received from the fuel chamber to be uniformly distributed with respect to an entire surface of the anode; a supply control unit that controls alcohol supply from the fuel chamber to plurality of inlets of the spreader; and a buffer installed between the spreader and the anode to limitedly pass the alcohol towards the anode; wherein the spreader comprises a channel plate having a plurality of flow channels that each guide the alcohol entering through one of the plurality of inlets of the spreader to be uniformly distributed with respect to a region of the anode and a nozzle plate that includes a plurality of nozzles that eject the alcohol in the flow channels towards the buffer; and wherein the buffer comprises a plurality of buffer panels physically separated from each other, each buffer panel being positioned to receive alcohol directed through the nozzle plate from one of the plurality of flow channels.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1 and 2 are cross-sectional views illustrating a conventional DAFC;

FIG. 3 is an exploded perspective view of a DAFC according to an embodiment of the present invention;

FIG. 4 is a cross-sectional view illustrating the DAFC of FIG. 3;

FIG. 5 is a plan view of a cell structure of a DAFC according to another embodiment of the present invention;

FIG. 6 is a schematic view illustrating a buffer permeated with methanol and acted upon by gravitational force according to an aspect of the present invention; and

FIG. 7 is a graph showing power density of a DAFC measured in horizontal and vertical positions of the cell depicted in FIG. 3, according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

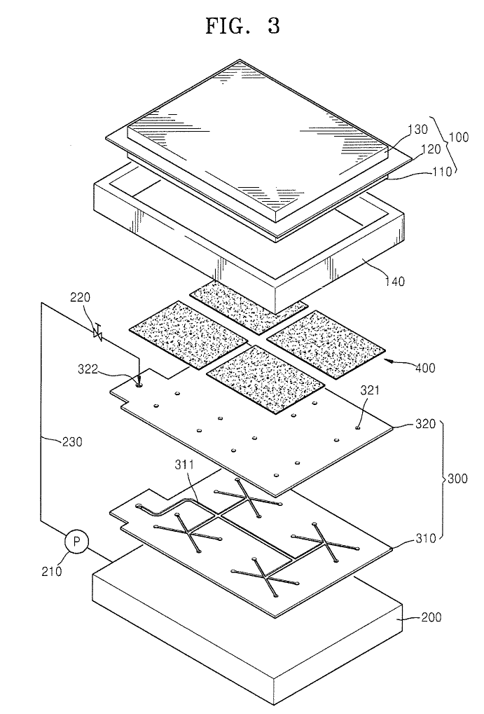

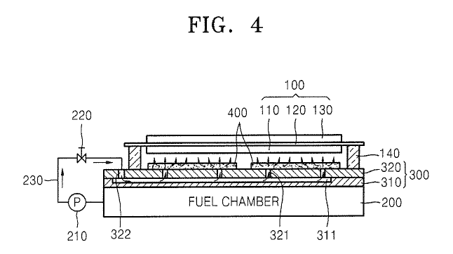

FIGS. 3 and 4 are respectively an exploded perspective view and a cross-sectional view illustrating a DAFC according to an embodiment of the present invention. The DAFC has a basic structure in that an electric generation reaction is induced by sending alcohol (such as methanol or ethanol) stored in a fuel chamber 200 to an anode 110 of an MEA 100. Therefore, electricity is generated through a chemical reaction between the alcohol supplied to the anode 110 and oxygen contained in entering to a cathode 130. The anode 110 and cathode 130 are on respective sides of an electrolyte membrane 120. The fuel chamber 200 can be formed as one piece with a main body of the DAFC or can be formed to be attachable to and detachable from the main body of the DAFC to allow for rapid replacement or refilling of the fuel chamber 200.

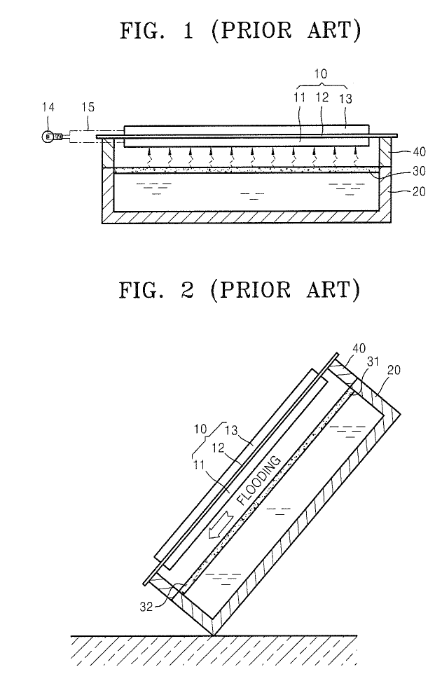

The DAFC has a supply control unit that controls the ON and OFF status of the DAFC using a pump 210 and a valve 220. That is, the alcohol in the fuel chamber 200 is not unlimitedly consumed through the vaporization membrane 30 (refer to FIG. 1) as in the art shown in FIG. 1. Instead, the alcohol in the fuel chamber 200 is supplied to the anode 110 when the pump 210 is in operation by the opening of the valve 220 installed on a supply tube 230. Accordingly, if the valve 220 is closed and the operation of the pump 210 is stopped, unnecessary fuel consumption can be prevented. In FIG. 3, the fuel chamber 200 and the pump 210 are separated members. However, the pump 210 can be omitted if the fuel chamber 200 includes a pressurized cartridge that has a pumping function. As such, the fuel supply can be selectively supplied using any device having a pressure differential. Further, the valve 220 can be disposed between the pump 210 and the fuel chamber 200 and can be any mechanism that substantially blocks the flow of fuel.

The DAFC includes a spreader 300 and a buffer 400 that supply the alcohol that enters through the supply tube 230 to the anode 110. The spreader 300 comprises a channel plate 310 and a nozzle plate 320. The channel plate 310 includes a flow channel 311 that allows the alcohol supplied through the supply tube 230 to be distributed to the entire main body of the DAFC. Accordingly, the alcohol supplied through the supply tube 230 is distributed to the entire surface of the channel plate 310 along the flow channel 311. In order to uniformly supply the alcohol to the entire surface of the anode 110, the flow channel 311 has a structure such that vaporization points of alcohol are distributed across an entire area of the anode 110. In FIG. 3, the flow channel 311 has a structure in which four X shaped regions connected to each other are symmetrically disposed in four quadrants (up and down and left and right) of the channel plate 310. However, the structure of the flow channel 311 can be provided in various shapes. In particular, by having a structure wherein the flow channel 311 in different regions of the channel plate has a convoluted or branched path, alcohol that enters the flow channel 311 does not move easily from one portion of the channel plate 310 to another when the DAFC is tilted. For example, alcohol that enters one of the X-shaped channels shown in FIG. 3 is more likely to remain trapped in the X-shaped channel when the DAFC is tilted rather than flow to another region of the channel plate 310. Thereby, uniform distribution of alcohol in the channel plate 310 is maintained even when the DAFC is tilted.

The nozzle plate 320 includes a plurality of nozzles 321 through which the alcohol that has been uniformly distributed through the flow channel 311 is ejected towards the anode 110. As an example, in FIG. 3, the nozzles 321 correspond to end points of the X-shaped portions of the flow channel. However, any location of the nozzles 321 that evenly distributes the alcohol contained in the flow channel 311 may be used. The nozzle plate 320 may include an inlet 322 that connects the supply tube 230 and the flow channel 311. It is to be understood that other configurations are possible. For example, the supply tube 230 may connect directly to the flow channel 311 without passing through the nozzle plate 320.

The buffer 400 is stacked on the nozzle plate 320. The buffer 400 absorbs alcohol ejected from the nozzles and allows the alcohol to limitedly pass towards the anode 110 in the same manner as the vaporization membrane 30 in the prior art. In particular, the buffer 400 does not directly contact the anode 110, but rather is separated by a housing 140 that defines a space through which vaporized alcohol passes to reach the anode 110. As used herein, the term “limitedly pass” indicates that alcohol passes to the anode according to a rate of vaporization of the alcohol from the buffer 400. The buffer 400 can be formed of a porous member, such as, for example, a porous ceramic, a fabric, a polymer porous medium or a combination thereof. The size of pores of the buffer 400 may be 60 μm or less, as will be described below. Alcohol ejected from the nozzles 321 of the nozzle plate 320 permeates into internal pores of the buffer 400, and afterwards, evaporates towards the anode 110.

When the DAFC having the above structure is in operation, the alcohol in the fuel chamber 200 can be supplied to the spreader 300 through the supply tube 231 while the pump 210 is in operation and the valve 220 is opened. Accordingly, the alcohol that enters through the inlet 322 is uniformly distributed on the channel plate 310 along the flow channel 311, and then, is ejected towards the anode 110 through the nozzles 321 of the nozzle plate 320. The alcohol ejected through the nozzles 321 permeates into the buffer 400, and after passing through pores of the buffer 400, evaporates towards the anode 110. Further, the pump 210 can be operated by a controller (not shown) at varying pressures to selectively change a flow rate of fuel to the inlet 322.

When the operation of the DAFC is stopped, the operation of the pump 210 is stopped and the valve 220 closes the supply tube 230. Accordingly, since a further alcohol supply is blocked, unnecessary alcohol consumption is prevented, and only the alcohol that has already entered in the flow channel 311 through the inlet 322 is consumed. In order to minimize alcohol consumption, the flow channel 311 may be formed to have a volume to contain an amount of alcohol sufficient for only a 5-minute operation or less. That is, if the volume of the flow channel 311 that connects the inlet 322 to the nozzles 321 is large, the amount of alcohol accommodated in the flow channel 311 increases. Accordingly, even if the valve 220 is closed, the amount of alcohol accommodated in the flow channel 311 at the time the valve 220 is closed is unnecessarily consumed and wasted. However, if the volume of the flow channel 311 is too small, the fluid pressure that must be applied to the flow channel 311 increases and supplying enough alcohol to operate the DAFC becomes more difficult. In order to prevent an increase in pressure due to a flow channel 311 that is too small, the flow channel may be formed to have a volume to contain an amount of alcohol sufficient for an operation of 0.5 minutes. Therefore, if the flow channel 311 is formed to have a volume to accommodate an amount of alcohol sufficient for a 0.5 to 5-minute operation after the fuel supply is blocked, the unnecessary consumption of alcohol can be minimized and an appropriate amount of fuel supplying to the anode 110 can be maintained. While not required, the pump 210 can be operated in reverse to pump out any fuel in the flow channel back into the fuel chamber 200 to further conserve fuel.

In the fuel supply structure in which the alcohol is uniformly distributed through the flow channel 311 as described above, different pressure drops in each of the flow channels 311 can create a problem. That is, the pressure drop of alcohol that reaches the nozzles 321 through the flow channels 311 is greatest at the nozzles 321 located farthest from the inlet 322. Thus, the flow rate of alcohol at the nozzles farthest from the inlet 322 is reduced. Accordingly, a difference in the amount of fuel provided occurs between a flow channel 311 near the inlet 322 and another flow channel 311 remote from the inlet 322. The supply imbalance of alcohol due to the pressure difference in the flow channels 311 can be prevented in one of two ways. First, the depth or width of the flow channel 311 can be gradually increased from the inlet 322 toward the remote regions so that the alcohol can smoothly flow to all regions of the channel plate 310. In other words, the cross-sectional area of the flow channel 311 may be increased from the inlet 322 toward the remote regions to compensate for the difference in fluid pressure. In this manner, problems of uneven flow related to the pressure difference between regions of the flow channel 311 near the inlet 322 and regions remote from the inlet 322 can be solved.

Alternatively, the differences in pressure in the flow channel 311 can be reduced to almost a negligible level by applying most of the pressure to the nozzles 321. For this purpose, the nozzles 321 must have a very small diameter, such as, for example, approximately 60 μm or less, to obtain the desired result. If the nozzles 321 have a diameter smaller than 60 μm, over 90% of the total pressure is applied to the nozzles 321, and the remaining 10% is applied to the flow channels 311. Therefore, the supply imbalance of alcohol to the anode 110 due to the pressure difference in the flow channels 311 is reduced to almost a negligible level.

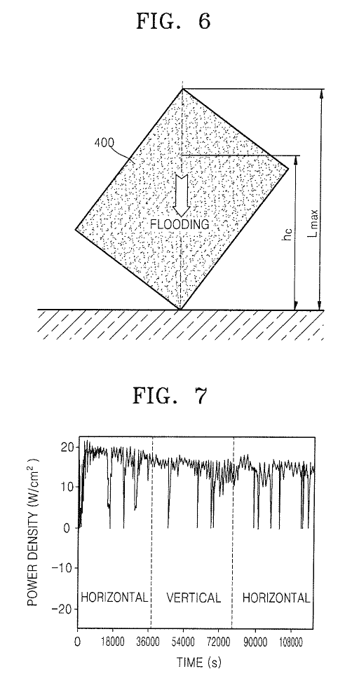

The buffer 400 may have a maximum length Lₘₐₓ that is smaller than the capillary height h_{c} of the buffer 400 with respect to alcohol (Lₘₐₓ<h_{c}). The terms “capillary height” or “h_{c}” of the buffer 400 refer to the critical height to which alcohol can rise through the internal pores of the buffer 400 by capillary force against the force of gravity. That is, below the critical height, alcohol can be soaked up into the pores of the buffer 400 even if the direction of flow is in the opposite direction to the gravitational force. Assuming that the buffer 400 has a rectangular shape, the maximum length Lₘₐₓ can be the length of the diagonal of the rectangle. As depicted in FIG. 6, when a buffer 400 is provided such that the maximum length Lₘₐₓ is longer than the capillary height h_{c} and the buffer 400 is positioned such that Lₘₐₓ is vertical, the alcohol permeated into the buffer 400 can flow down from areas of the buffer 400 above h_{c} due to gravitational force. In such a case, the amounts of alcohol in an upper region and a lower region of the buffer 400 can be different from each other. For this reason, in order to avoid the effect of the gravitation force regardless of the position of the DAFC, as described above, and in order to prevent an uneven distribution of alcohol, the buffer 400 may be formed to have the maximum length Lₘₐₓ that is less than the capillary height h_{c}. The capillary height h_{c} of the buffer 400 depends on the composition and physical characteristics, such as pore size, of the buffer material and can be readily determined by experimentation. For example, a buffer material can be positioned vertically with a lower end submerged in alcohol, and the height to which the alcohol rises in the buffer material can be measured to determine the h_{c} value for the material. If it is not possible to provide a buffer 400 as a single panel having a maximum length Lₘₐₓ smaller than the capillary height h_{c} with respect to alcohol for a particular size of the channel plate 310 and nozzle plate 320, the buffer 400 may be provided that is divided into physically separate panels as shown in FIG. 3. Since h_{c} is determined based on the composition of the buffer material and Lₘₐₓ is determined based on physical dimensions of a panel, the separate panels may satisfy the limitation of Lₘₐₓ<h_{c} in situations where a larger panel would not. As shown in FIG. 3, the separate panels of the buffer 400 are each located over one of the regions of the channel plate 310.

FIG. 7 is a graph showing the power density of a DAFC according to the embodiment of the present invention depicted in FIG. 3, measured in horizontal and vertical positions. In the DAFC of the embodiment depicted in FIG. 3, the buffer 400 is formed to have the maximum length Lₘₐₓ of the main body smaller than the capillary height h_{c}, as described above. Referring to FIG. 7, there was found to be no significant power output difference between the DARC in the horizontal position and the DAFC in the vertical position.

Accordingly, when a fuel supply system having the above structure is employed, a DAFC that can reduce unnecessary fuel consumption during a shut down operation and that can stably and uniformly supply fuel during a normal operation can be realized.

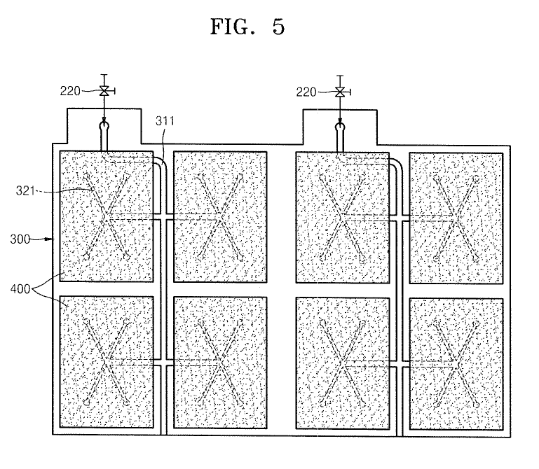

FIG. 5 is a plan view of a cell structure of a DAFC according to another embodiment of the present invention. In particular, the spreader 300 can include multiple flow channels 311 and multiple corresponding valves 220, nozzles 321 and buffers 400 to supply the alcohol to the anode 110 through multiple paths. As a non-limiting example according to FIG. 5, the configuration of the flow channels 311, corresponding nozzles 321 and buffer 400 as shown in FIG. 3 may be duplicated on the channel plate 300 so that two identical structures are formed side-by-side. Such valves 220, as well as the pump 210, can be selectively operated by a controller and/or processor to regulate the fuel being supplied.

The DAFC according to aspects of the present invention has the following and/or other advantages.

Unnecessary fuel consumption can be reduced since a further fuel supply from a fuel chamber is blocked by closing a valve when the DAFC is not in operation.

Since the fuel supply is blocked when the DAFC is not in operation, the phenomenon of crossover, which occurs when an excessive amount of alcohol is present at the anode, can be prevented, thereby increasing the lifetime of the DAFC.

When the maximum length of a buffer or a separate buffer panel is appropriately designed, a fuel supply difference in different positions of the buffer due to gravitational force can be avoided.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A direct alcohol fuel cell comprising:
a membrane electrode assembly in which an anode, an electrolyte membrane, and a cathode are stacked;
a fuel chamber in which alcohol is stored; and
a fuel supply system that supplies the alcohol to the anode from the fuel chamber, the fuel supply system comprising:
a spreader that includes an inlet that receives alcohol from the fuel chamber and that allows the alcohol received from the fuel chamber to be uniformly distributed with respect to an entire surface of the anode;
a supply control unit that controls alcohol supply from the fuel chamber to the inlet of the spreader; and
a buffer between the spreader and the anode to limitedly pass the alcohol towards the anode.

2. The direct alcohol fuel cell of claim 1, wherein the supply control unit comprises a supply tube that connects the fuel chamber to the inlet of the spreader, a pump that pumps the alcohol to the inlet of the spreader from the fuel chamber through the supply tube, and a valve that selectively opens and closes the supply tube.

3. The direct alcohol fuel cell of claim 1, wherein the buffer comprises a porous material.

4. The direct alcohol fuel cell of claim 3, wherein the porous material is one of a porous ceramic, a fabric, and a polymer porous medium or a combination thereof.

5. The direct alcohol fuel cell of claim 3, wherein the buffer has a maximum length Lₘₐₓ smaller than a capillary height h_{c} of the buffer such that alcohol is retained in pores of the buffer by a capillary force and a distribution of alcohol in the buffer is not altered by gravity.

6. The direct alcohol fuel cell of claim 3, wherein the buffer comprises a plurality of panels physically separated from each other and each panel has a maximum length Lₘₐₓ smaller than a capillary height h_{c} of the buffer such that alcohol is retained in the panel by capillary force and a distribution of alcohol in the panel is not altered by gravity.

7. The direct alcohol fuel cell of claim 1, wherein the spreader comprises a channel plate having a flow channel that guides the alcohol entering through the inlet of the spreader to be uniformly distributed with respect to an entire surface of the anode, and a nozzle plate that is stacked on the channel plate and that includes a plurality of nozzles that eject the alcohol in the flow channels towards the buffer.

8. The direct alcohol fuel cell of claim 6, wherein the flow channel comprises a plurality of branched regions such that a flow of alcohol from one branched region to another when the direct alcohol fuel cell is tilted is inhibited.

9. The direct alcohol fuel cell of claim 7, wherein the cross-sectional area of the flow channel is gradually increased away from the inlet of the spreader so as to reduce a pressure drop difference in the flow channel.

10. The direct alcohol fuel cell of claim 7, wherein the flow channel has a total volume to contain an amount of alcohol that is consumed in a operation of the direct alcohol fuel cell in 0.5 minutes to 5 minutes when a further alcohol supply is stopped.

11. The direct alcohol fuel cell of claim 7, wherein the nozzles of the nozzle plate have a diameter such that approximately 90% or more of the fluid pressure generated in a space between the flow channels and the nozzles is applied to the nozzles.

12. The direct alcohol fuel cell of claim 11, wherein the nozzles have a diameter of 60 μm or less.

13. A direct alcohol fuel cell comprising:
a membrane electrode assembly in which an anode, an electrolyte membrane, and a cathode are stacked;
a fuel chamber in which alcohol is stored; and
a fuel supply system that supplies the alcohol to the anode from the fuel chamber, the fuel supply system comprising:
a spreader that includes a plurality of inlets that receive alcohol from the fuel chamber and that allows the alcohol received from the fuel chamber to be uniformly distributed with respect to an entire surface of the anode;
a supply control unit that controls alcohol supply from the fuel chamber to plurality of inlets of the spreader; and
a buffer between the spreader and the anode to limitedly pass the alcohol towards the anode;
wherein the spreader comprises a channel plate having a plurality of flow channels that each guide the alcohol entering through one of the plurality of inlets of the spreader to be uniformly distributed with respect to a region of the anode and a nozzle plate that includes a plurality of nozzles that eject the alcohol in the flow channels towards the buffer; and
wherein the buffer comprises a plurality of buffer panels physically separated from each other, each buffer panel being positioned to receive alcohol directed through the nozzle plate from one of the plurality of flow channels.

14. The direct alcohol fuel cell of claim 1, wherein the fuel chamber is attachable to and detachable from the main body of the direct alcohol fuel cell.

15. The direct alcohol fuel cell of claim 1, wherein the fuel chamber is a pressurized cartridge that has a pumping function.

16. A direct alcohol fuel cell connectable to a fuel chamber in which fuel is stored, the fuel cell comprising:
a membrane electrode assembly in which an anode, an electrolyte membrane, and a cathode are stacked; and
a fuel supply system that includes a supply unit that selectively applies a pressure differential to supply the fuel stored in the fuel chamber to the anode, and a spreading unit disposed between the supply unit and the anode and which spreads the supplied fuel substantially evenly across the anode.

17. The direct alcohol fuel cell of claim 16, further comprising an attachment at which the fuel chamber is detachably connected to the fuel supply system.

18. The direct alcohol fuel cell of claim 16, wherein the supply unit comprises a valve which selectively blocks a flow from the fuel from the fuel chamber to the spreading unit.

19. The direct alcohol fuel cell of claim 16, wherein the supply unit comprises a pump which selectively pumps the fuel from the fuel chamber to the spreading unit.

20. The direct alcohol fuel cell of claim 16, wherein the spreading unit comprises at least one fuel channel facing one surface of the anode which receives the supplied fuel and channels the fuel to positions opposite a majority of the one surface.

21. The direct alcohol fuel cell of claim 16, wherein the spreading unit comprises a porous buffer having sufficient pores such that a distribution of fuel in the buffer is not altered by gravity.

22. The direct alcohol fuel cell of claim 21, wherein the buffer has a maximum length Lₘₐₓ smaller than a capillary height h_{c} of the buffer such that the fuel is retained in pores of the buffer by a capillary force and a distribution of alcohol in the buffer is not altered by gravity.

23. The direct alcohol fuel cell of claim 21, wherein:
the spreading unit comprises at least one fuel channel facing one surface of the anode which receives the supplied fuel and channels the fuel to positions opposite a majority of the one surface, and
the buffer is disposed between the at least one fuel channel and the anode.
